(19) United States
(12) Patent Application Publication
(10) Pub. No.: US 2025/0245470 A1
(43) Pub. Date: Jul. 31, 2025

(54) PACKAGE EMBODIMENT COMPRISING A RFID/NFC LABEL

(71) Applicant: ERDER PLASTIK SANAYI VE TICARET LIMITED SIRKETI, Kepez, Antalya (TR)

(72) Inventor: Erdem ERSOY, Kepez, Antalya (TR)

(21) Appl. No.: 18/685,761

(22) PCT Filed: Dec. 21, 2022
(86) PCT No.: PCT/TR2022/051558

§ 371 Date: Feb. 22, 2024

(30) Foreign Application Priority Data
May 5, 2022 (TR) 2022/007339

(51) Int. Cl. G06K 19/077

(52) U.S. Cl. CPC G06K 19/07758

(57) ABSTRACT

A packaging embodiment with a RFID/NFC label containing various information about the product (production place, production date, logistics history, departure date from the dealer etc.). Whereon the end user sees the information by placing a RFID/NFC label between a IML/BML label in any package (can, plastic can, cap, bucket, bottle etc.) where the IML (In mould Labelling) and the BML (Blow Moulding Labelling) labels contain the package container, in-moulding label, and RFID/NFC label.

### TECHNICAL FIELD

The invention relates to a packaging embodiment made by placing a RFID/NFC label between IML/BML label and plastic package on any packages (comprising a RFID/NFC label containing various information (production place, production date, logistics history, departure date from the dealer etc.) whereon user sees the information.

### PRIOR ART

In current status plastic packages are produced in various forms and colours enabling or disabling inside visibility depending on features of the product put therein or customer's request. As per reason for said production form colour, thickening intensity and quality of the product put into the package is unlikely to be discovered without opening the package. In this case, while selecting material, disadvantages for consumer occur.

In the present related art while selecting production form and material of plastic packages, not only causing disadvantages for consumer but also disadvantages such as inability to understand if the product in the package is original and inability to track shelf life thereof are seen.

Upon technical field search an application numbered EP3583052B1 is encountered, and it relates to a cigarette package comprising box body, an inner wrap containing aluminium layer and a RFID/NFC. In the said cigarette package, when cover is in close position, antenna of RFID/NFC label is prevented by aluminium layer and thus RFI>D/NFC label is structured in a manner not to interact with any device equipped with NFC device.

As stated, the invention relates to a cigarette package comprising RFID/NFC label and does not disclose an embodiment capable to solve above mentioned disadvantages.

As a result, due to above-described disadvantages and inadequacy of existing solutions it has been necessary to make development in the related art.

### PURPOSE OF THE INVENTION

Differently from the existing related art, the invention aims to disclose an embodiment having different technical features providing a new solution and aims to solve above mentioned negativities.

Primary purpose of the invention is to disclose a packaging embodiment made by placing a RFID/NFC label between IML/BML label and plastic package on any packages (comprising a RFID/NFC label containing various information (production place, production date, logistics history, departure date from the dealer etc.) whereon user sees the information and thus to enable consumer to have information about quality and content of the product without opening the package.

Another purpose of the invention is to facilitate discovering if the product in the package is original and thus prevent fraud.

Another purpose of the invention is to facilitate track of shelf life of product in the package and thus provide advantage in respect to problem free access to products by consumer.

In order to achieve the above-mentioned purposes, the invention relates to a package embodiment for use in any packages wherein in mould labels are used and comprising;
a package container wherein product is kept,
an inside form label where onto said package container is connected,
RFID/NFC label wherein information about the product is stored and which is located between package container and inside form label and allowing readability of said information by a mobile device.

In a preferred embodiment of the invention said in mould label (2) is an IML (In Mould Labelling) or BML (Blow Moulding Labelling) label.

The structural and characteristics features of the invention and all advantages will be understood better in detailed descriptions with the figures given below and with reference to the figures, and therefore, the assessment should be made taking into account the said figures and detailed explanations.

### FIGURES TO HELP UNDERSTANDING OF INVENTION

FIG. 1 is a view showing fundamental operating principle of package embodiment of the invention.

FIG. 2 is an illustrative view showing demounting status of package embodiment of the invention.

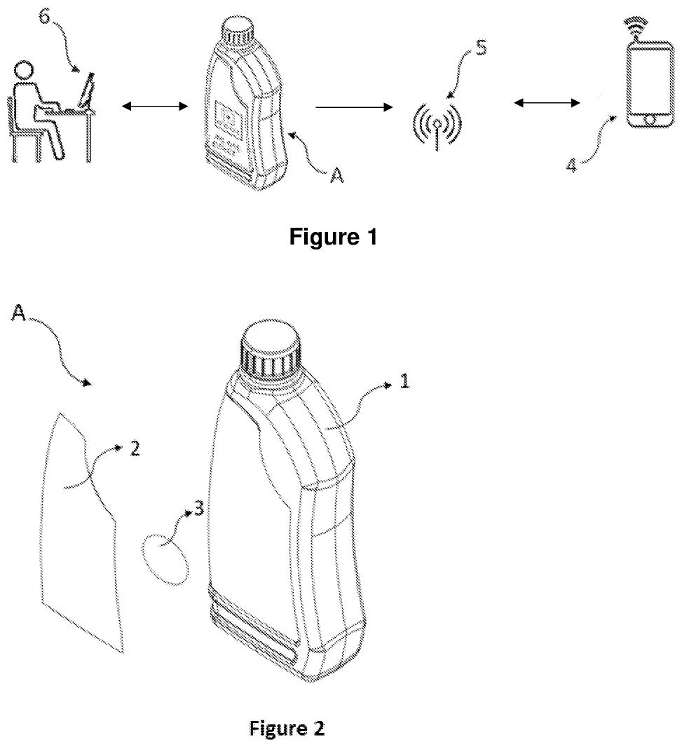

The figures are not necessarily to be scaled and the details not necessary for understanding the present invention might have been neglected. In addition, the components which are equivalent to great extent at least or have equivalent functions at least have been assigned the same number.

### DESCRIPTION OF PART REFERENCES

A. Package Embodiment
1. Package Container
2. In Mould Label
3. RFID/NFC Label
4. Mobile Device
5. Antenna
6. Computer

### DETAILED DESCRIPTION OF THE INVENTION

In this detailed description, the preferred embodiments of the invention have been described in a manner not forming any restrictive effect and only for purpose of better understanding of the matter.

Invention relates to a packaging embodiment (A) made by placing a RFID/NFC label between in-moulding label (2) and plastic package on any packages (comprising a RFID/NFC label (3) containing various information (production place, production date, logistics history, departure date from the dealer etc.) whereon user sees the information.

As shown in FIG. 2, package embodiment (A) of the invention comprises a package container (1), in-moulding label (2) and RFID/NFC label (3).

Package container (1) is moulded in desired structure and structured in a manner allowing storage of material therein. Said in mould labelling (2) is a label of type called in-mould labelling. Onto said RFID/NFC label (3) data such as production place, production date, logistic background, departure date from dealer needed to be known by consumer tan be installed from a computer (6) and rear surface of the RFID/NFC label (3) is structured in sticky form to allow connection to in mould labelling (2). Connection to in mould label (2) is provided by means of sticky part provided on rear surface of said RFID/NFC label (3). In mould label (2) of which photo is printed is placed into mould before production of package container (1) and thus connection of package container (1) and in mould label (2) is provided during injection. Thus RFID/NFC label (3) remains between package container (1) and in-mould label (2) and is protected against damages that might come from outside and further attempt to RFID/NFC label (3) is not possible. When there is any attempt to RFID/NFC label (3) from outside, consumer will have information about originality of the package as deformation will occur onto the package.

RFID/NFC label (3) runs based on principle of transmitting data via an antenna (5) through radio waves. Receiving data from RFID/NFC label (3) is provided by means of data exchange from a short distance by means of contact of a mobile device (4) compatible with NFC and RFID/NFC label (3). Thus, safe track of the product inside the package container (1) is provided by means of keeping the RFID/NFC label (3) from the mobile device (4) safe from production of the product therein until receipt by end user and enabling track of data needed to be known by the consumer.

1. A package embodiment comprising a package container wherein product is stored and in mould labels are used for use in any kind of packaging, the package embodiment further comprising;
an in mould label connected to said package container; and
a RFID/NFC label wherein information about the product is stored and which is located between said package container and said in mould label and allowing readability of said information by a mobile device.

2. The package embodiment according to claim 1, wherein said in mould label is an IML or BML label.

3. The package embodiment according to claim 1, wherein said information stored in the RFID/NFC label is a production place and/or production date and/or logistic background and/or time of departure from dealer.
